(19) United States
(12) Patent Application Publication
(10) Pub. No.: US 2005/0170240 A1
(43) Pub. Date: Aug. 4, 2005

(54) Electrochemical energy store

(75) Inventors: Johann German, Weinstadt (DE); Thomas Soczka-Guth, Schelklingen (DE)

Correspondence Address: DAVIDSON, DAVIDSON & KAPPEL, LLC, 485 SEVENTH AVENUE, 14TH FLOOR, NEW YORK, NY, 10018, US

(73) Assignee: DaimlerChrysler AG, Stuttgart (DE)

(21) Appl. No.: 11/043,353

(22) Filed: Jan. 26, 2005

(30) Foreign Application Priority Data
Feb. 4, 2004 (DE) 10 2004 005 393.6

(51) Int. Cl. H01M 10/50; H01M 2/10

(52) U.S. Cl. 429/120; 429/156; 429/72

(57) ABSTRACT

In an exemplary embodiment of the present invention, an electrochemical store comprises a plurality of heat exchange units and a plurality of electrochemical storage cells arranged in an array, alongside one another, and between pairs of the heat exchange unit. The heat exchange units include heat exchange channels for flow of a temperature control fluid. A forward flow distribution channel is coupled to the heat exchange channels for ingress of the temperature control fluid and a return flow distribution channel is coupled to the heat exchange channels for egress of the temperature control fluid flow. Pursuant to a feature of the present invention, a pressure-tight and watertight battery box is arranged to receive and enclose the heat exchange units and the electrochemical storage cells, and the battery box is arranged and configured to mount a water outlet and venting device.

This application claims priority to German Patent Application DE 10 2004 005 393.6, filed Feb. 4, 2004, which is hereby incorporated by reference herein.

### BACKGROUND

The present invention is directed to an electrochemical energy store.

On the basis of the applicable regulations, an enclosure for the energy store, such as a battery box, must ensure fire protection up to 900° C. in the event of fire. Furthermore, the electronic components which are required for the connection of the individual modules and/or memory cells and/or storage cells must be protected against electromagnetic radiation (EMC). For this reason, a battery box is generally manufactured from thin-walled steel plate sheet steel, in which case the cover should be watertight and should likewise be sealed with an EMC shield. The use of a support structure according to the exemplary embodiment of present invention makes it possible to comply with these regulations.

However, there is a problem on the one hand in that temperature differences result in pressure building up in the battery box when the battery box has a watertight seal. This build up in pressure should be equalized.

On the other hand, there is always a risk of heat exchange units leaking, and of the cooling liquid, generally water, being able to emerge. This can lead to damage to electronic components. In particular, major damage can occur in the electronics and in the electrical system since the connections of the modules are subject to high voltages and may be damaged when cooling liquid emerges.

### BRIEF SUMMARY OF THE INVENTION

The present invention provides a battery box that satisfies fire and EMC protection regulations, and that prevents damage caused by temperature differences or the emergence of cooling liquids.

In an exemplary embodiment of the present invention, an electrochemical store comprises a plurality of heat exchange units and a plurality of electrochemical storage cells arranged in an array, alongside one another, and between pairs of the heat exchange unit. The heat exchange units include heat exchange channels for flow of a temperature control fluid. A forward flow distribution channel is coupled to the heat exchange channels for ingress of the temperature control fluid and a return flow distribution channel is coupled to the heat exchange channels for egress of the temperature control fluid flow. Pursuant to a feature of the present invention, a pressure-tight and watertight battery box is arranged to receive and enclose the heat exchange units and the electrochemical storage cells, and the battery box is arranged and configured to mount a water outlet and venting device.

### BRIEF DESCRIPTION OF THE DRAWINGS

FIG. 1 shows a heat exchange unit.

FIG. 2 illustrates an exploded enlargement of a detail of the heat exchange unit of FIG. 1.

FIG. 3 shows a heat exchange unit having twelve heat exchange channels.

FIG. 4 illustrates an exploded enlargement of a detail of two of the heat exchange channels shown in FIG. 3.

FIG. 5 shows an energy store in an assembled state.

FIG. 6 shows a perspective view of a support housing according to a feature of the present invention, for use with the energy store illustrated in FIG. 5.

FIG. 7 shows a perspective, exploded view of a support housing of the type illustrated in FIG. 6, before its assembly.

FIG. 8 shows an enlarged section along the line VIII-VIII of FIG. 7.

FIG. 9 shows an enlargement of a detail marked by the letter “X” in FIG. 7.

FIG. 10 shows an enlargement of a detail marked by the letter “Y” in FIG. 7.

FIG. 11 shows a section along the line XI-XI of FIG. 7.

FIG. 12 shows the heat exchange unit of FIG. 1 with storage cells inserted between the heat exchange channels of the heat exchange unit.

FIG. 13 shows an exploded view of a design for an energy store and a support housing according to a feature of the present invention.

FIG. 14 shows an enlargement of a detail marked by the letter “Z” in FIG. 13.

FIG. 15 shows a design of an energy store in the support housing according to a feature of the present invention, in the form of a perspective illustration before final assembly.

FIG. 16 shows a perspective view of the energy store partially assembled, with connection of the storage cells.

FIG. 17 shows a further perspective view of a completely assembled energy store in the support housing according to a feature of the present invention.

FIG. 18 shows a perspective view of an installation of a self-supporting unit comprising the energy store and support housing according to a feature of the present invention, in a battery box.

FIG. 19 shows a further perspective view of the energy store with the support housing and inserted into the battery box, as shown in FIG. 18.

FIG. 20 shows a perspective view of a water outlet and venting screw including a water outlet and venting disc.

FIG. 21 shows a perspective view of the water outlet and venting screw and the water outlet and venting disc, of FIG. 20, before assembly.

FIG. 22 shows a side view of the water outlet and venting screw and the water outlet and venting disc.

FIG. 23 shows a side view of the water outlet and venting screw.

FIG. 24 shows a longitudinal section through the water outlet and venting screw of FIG. 23.

FIG. 25 shows a side view of the water outlet and venting disc.

FIG. 26 shows a longitudinal section through the water outlet and venting disc of FIG. 25.

FIG. 27 shows a plan view of a battery box with centering bolt, attachment screws and water outlet and venting screws.

FIG. 28 shows a section of the battery box, along line XXVIII-XXVIII of FIG. 27.

FIG. 29 shows a perspective view of a self-supporting energy store which has been inserted into a battery box and has storage cells and heat exchange units, and an external cooling circuit.

FIG. 30 shows a side view of the battery box with the energy store of FIG. 29.

FIG. 31 shows a perspective view of a version with an external cooling component structure.

FIG. 32 shows a plan view of a battery box, installed in a vehicle, with the energy store according to the present invention.

FIG. 33 shows a perspective view of a large number of energy stores according to the present invention, with external cooling components.

FIG. 34 shows a further perspective view of a battery box with the energy store according to the present invention, and with cooling components flange-connected directly to the battery box.

FIG. 35 shows a perspective view of an equalization container.

### DETAILED DESCRIPTION

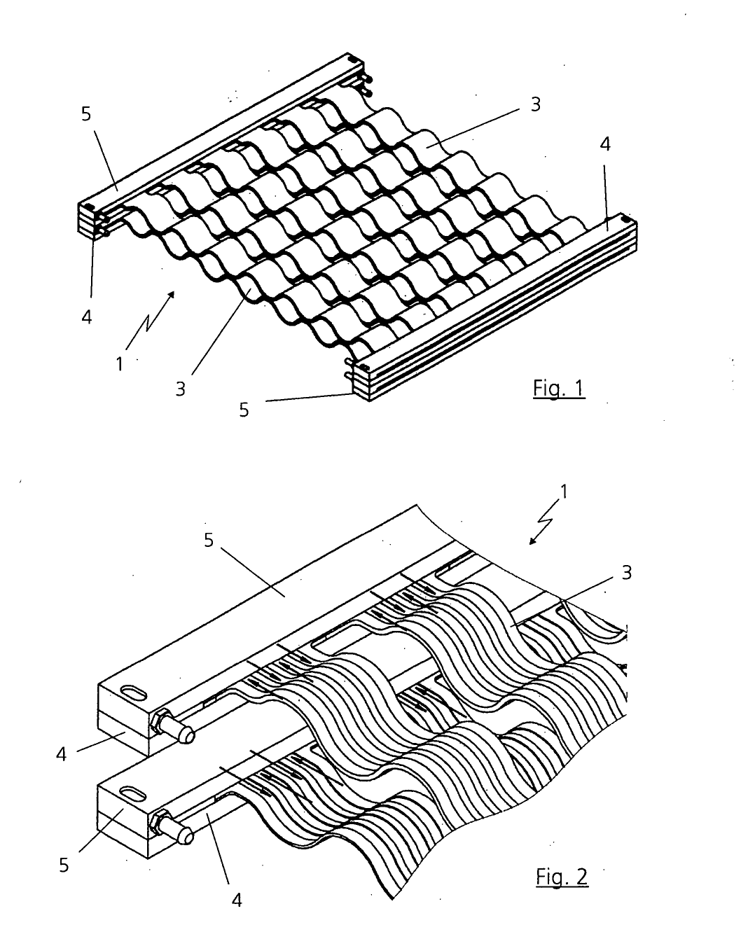

FIGS. 1 to 5 show the general design features of an electrochemical energy store. Since such an electrochemical energy store is, in general, known from the prior art, only the major parts will be described in more detail in the following text. In principle, the energy store may be designed as required by a respective application. However, according to a feature of the present invention, the energy store is designed as a self-supporting unit, as will be described in more detail in the following text.

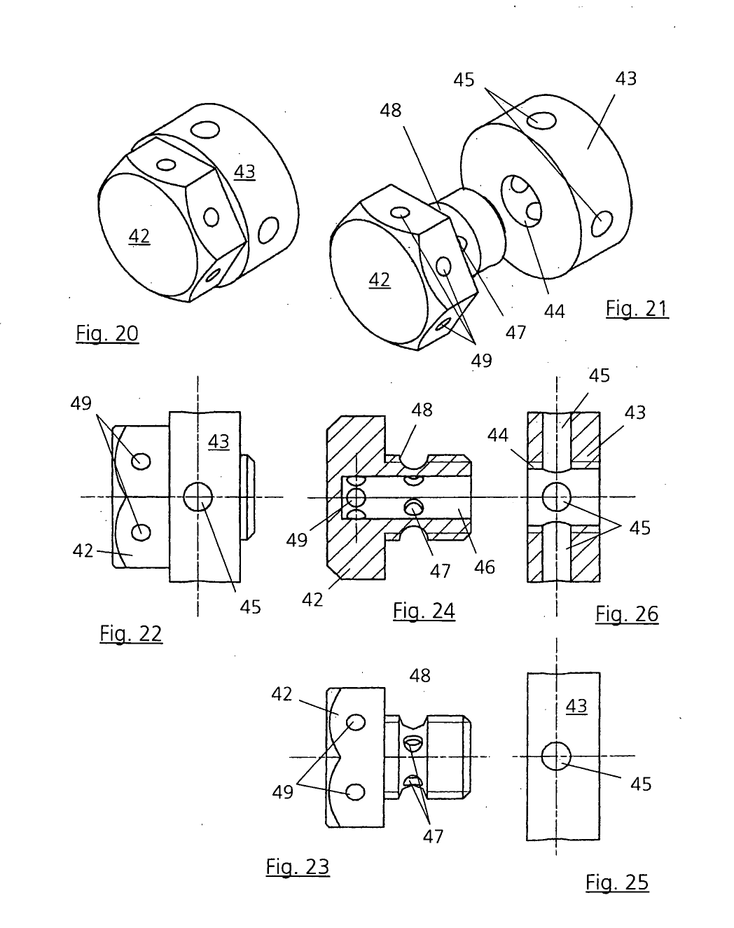

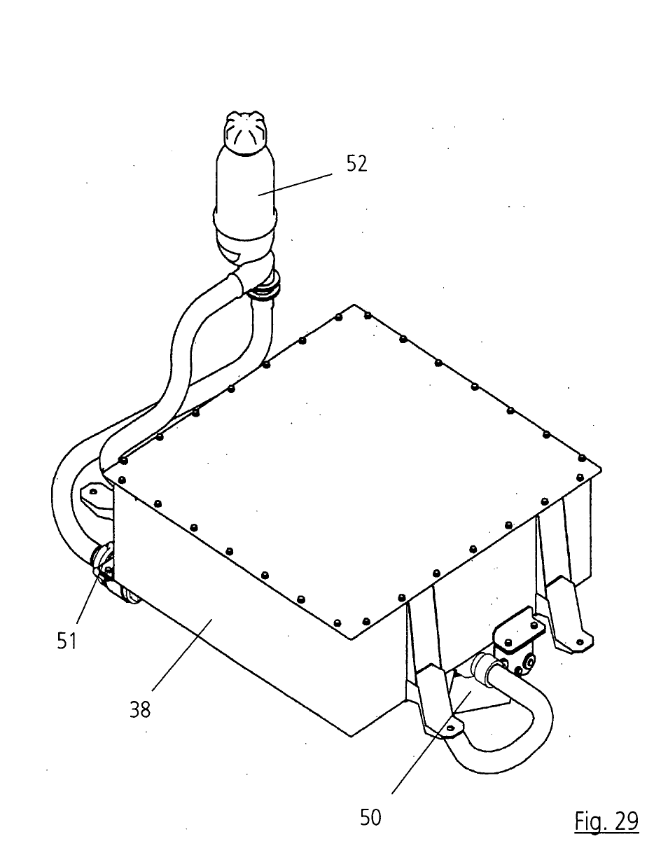

According to a feature of the present invention, a water outlet and venting device comprises a water outlet and venting screw coupled to a water outlet and venting disc. An exemplary embodiment of the water outlet and venting device feature of the present invention will be described in the following text with reference to FIGS. 20 and 28.

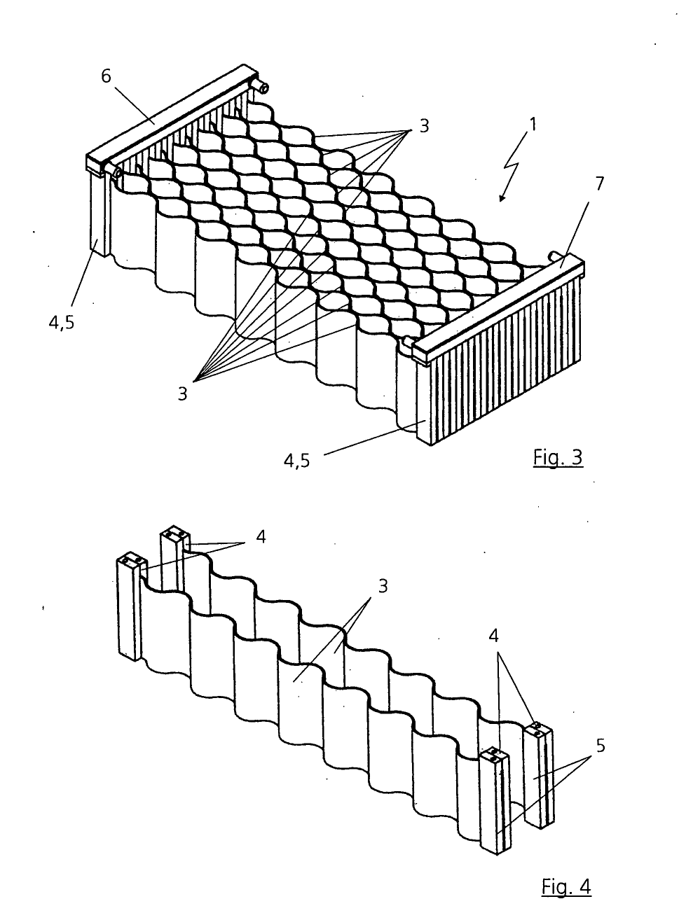

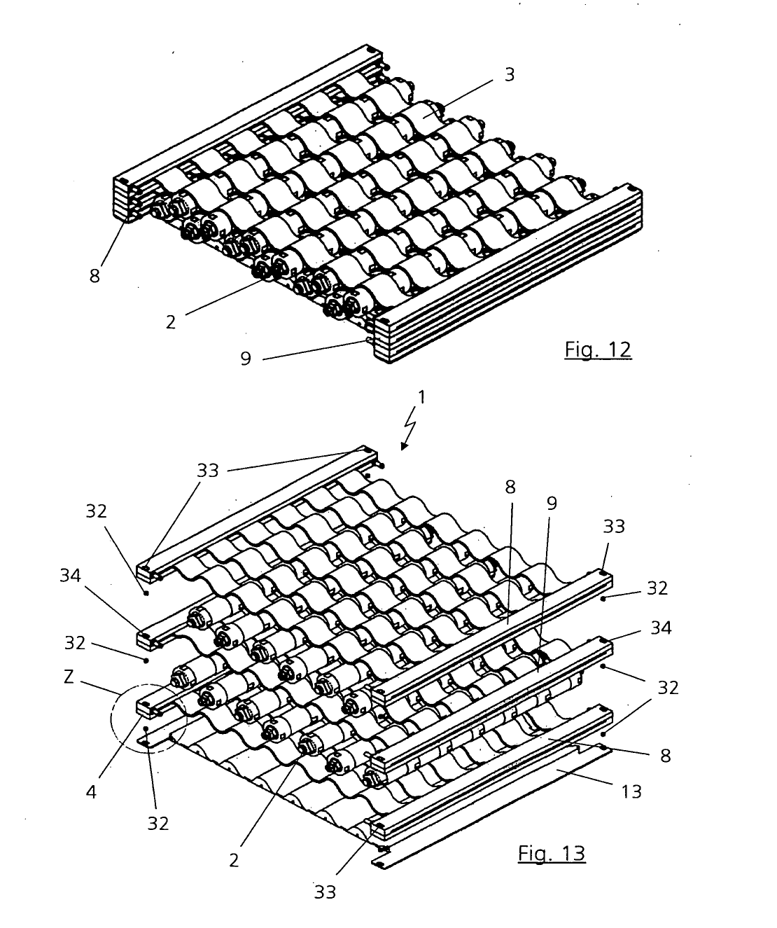

A plurality of heat exchange cooling units 1, between which storage cells 2, for example Ni/MeH cells, are arranged, is provided in the energy store (see, for example, FIGS. 12 and 13). As shown in FIG. 1, the heat exchange units 1 are designed, for example, with six circulation channels or heat exchange channels 3. A temperature control fluid is circulated through the heat exchange channels 3. The flow runs in either direction on a plane and in either direction parallel to their planes (see FIG. 2). The flow takes place via circulation distribution channels 4 and 5 which, depending on the arrangement, represent forward flow circulation distribution channels or return flow circulation distribution channels. In the case of Ni/MeH modules and cells, the heat exchange channels 3 are formed from a number of parts, owing to the configuration of the Ni/MeH modules.

As can be seen in FIG. 3, twelve rows of heat exchange channels 3 are provided, and a forward flow distributor 6 and a return flow distributor 7 are provided for lithium ion cells. The flow likewise runs in either direction on a plane and parallel to their planes, based on an opposing flow principle, as shown in FIG. 2.

FIG. 4 shows a detail of two heat exchange channels 3, two forward flow circulation distribution channels 4, and two return flow circulation distribution channels 5. In the case of lithium ion cells, only one heat exchange channel 3 is in each case provided, owing to the configuration of the cells.

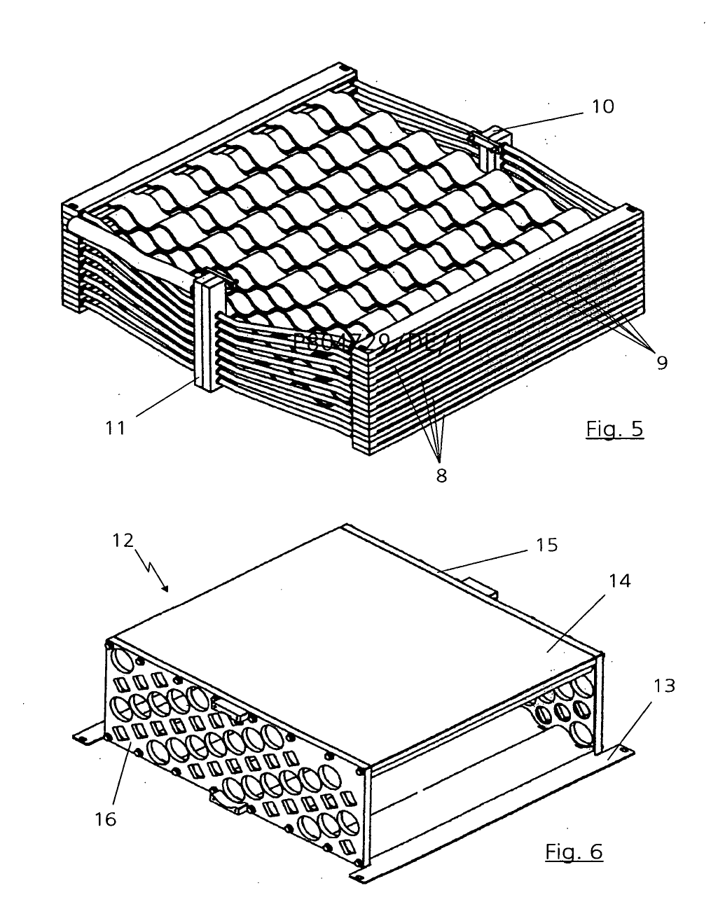

FIG. 5 shows the assembly of heat exchange cooling units 1 of the type illustrated in FIG. 1, for use with forty-six Ni/MeH modules. The assembly includes a stack of four cooling units indicated by the reference numeral 8 and four cooling units indicated by the reference numeral 9, each arranged between a pair of units 8, together with a forward flow distributor 10 and a return flow distributor 11.

Referring now to FIGS. 6 to 19, there is illustrated a design for an energy store in accordance with a feature of the present invention. As shown, the heat exchange units 1 and the energy storage cells 2 are assembled in the form of a self-supporting unit. Pursuant to an exemplary embodiment of the present invention, a support housing 12 is used to provide a self-support structure for the energy store, with a lower support pressure plate mount 13 on the lower face, an upper support pressure plate 14 on the upper face, and two side support clamping plates 15 and 16, as shown, for example, in FIG. 6.

Since the energy store according to the exemplary embodiment of the present invention is in the form of a self-supporting unit, the individual modules, in particular the storage cells, and the heat exchange units which are arranged between each of the storage cells, can be installed and assembled with the support housing outside the battery box. After final assembly, the entire self-supporting unit can then be inserted into any desired battery box.

It is also advantageous that the battery box may then form the necessary fire and EMC protection, and may be designed to be sealed appropriately for this purpose. Furthermore, there is no longer a need to design the battery box as a mechanism to support the now self-supporting energy store. Thus, according to the present invention, a battery box can be fabricated with less and lighter materials and will therefore be of lighter construction, and be less expansive to manufacture.

The self-supporting energy store according to the present invention may be used in a vehicle, or else for any other application. If it is installed in a vehicle, it can be installed in the existing spare wheel well. In the case of a new development, the required physical space could be provided, for example, in the bottom structure of the vehicle.

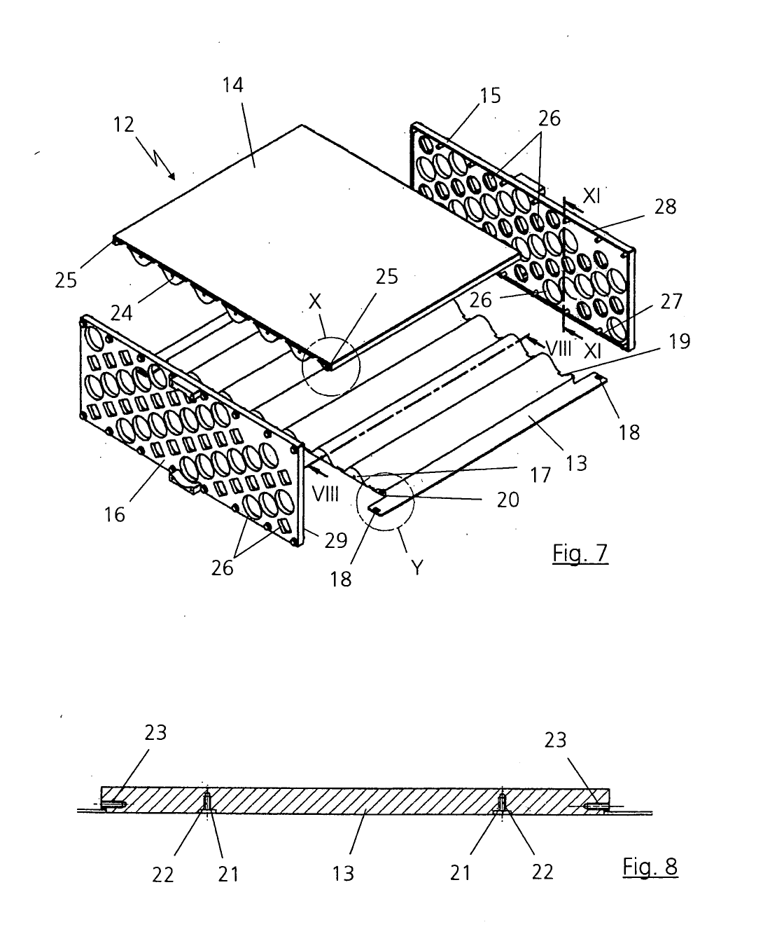

FIG. 7 shows a perspective, exploded view of the design of the support housing 12, according to the exemplary embodiment of the present invention. The lower support pressure plate mount 13 has a curved, radius contour 17, which complements and merges with the curved, radius contour of the heat exchange channels 3, so that the heat exchange channels 3 are optimally secured and fixed in the support housing 12.

In order to secure cooling units 8, 9 (FIG. 5), the lower support pressure plate mount 13 is provided with four elongated holes 18 formed at the outer end corners thereof. A cooling unit 8, 9 is positioned and fixed in the x direction by means of the elongated holes 18.

The elongated holes 18 allow the cooling unit 8, 9 together with the circulation distribution channels 4, 5, which are subject to temperature fluctuations, to expand in the y direction, so that no stresses occur.

The lower support pressure plate mount 13 has clamping grooves 19 and 20 at the ends. The clamping grooves 19 and 20 are used to uniformly absorb a defined clamping force from the side support clamping plates 15 and 16 (see the detail Y in FIG. 10).

FIG. 8 shows a longitudinal section along the line VIII-VIII of FIG. 7, through the lower support pressure plate mount 13. Cylindrical centering holes 21 can be seen in this section. The cylindrical centering holes 21 interact via threaded holes 22 with screws which are arranged in a battery box, which will be described below. The self-supporting unit is fixed in the horizontal direction by means of centering bolts which are arranged in the battery box and passed through the cylindrical centering holes 21, with shear forces being absorbed by the cylindrical centering holes 21 and centering bolts in the battery box.

At the sides, the lower support pressure plate mount 13 is provided with threaded holes 23, via which the side support clamping plates 15 and 16 are attached, by means of corresponding, inserted screws.

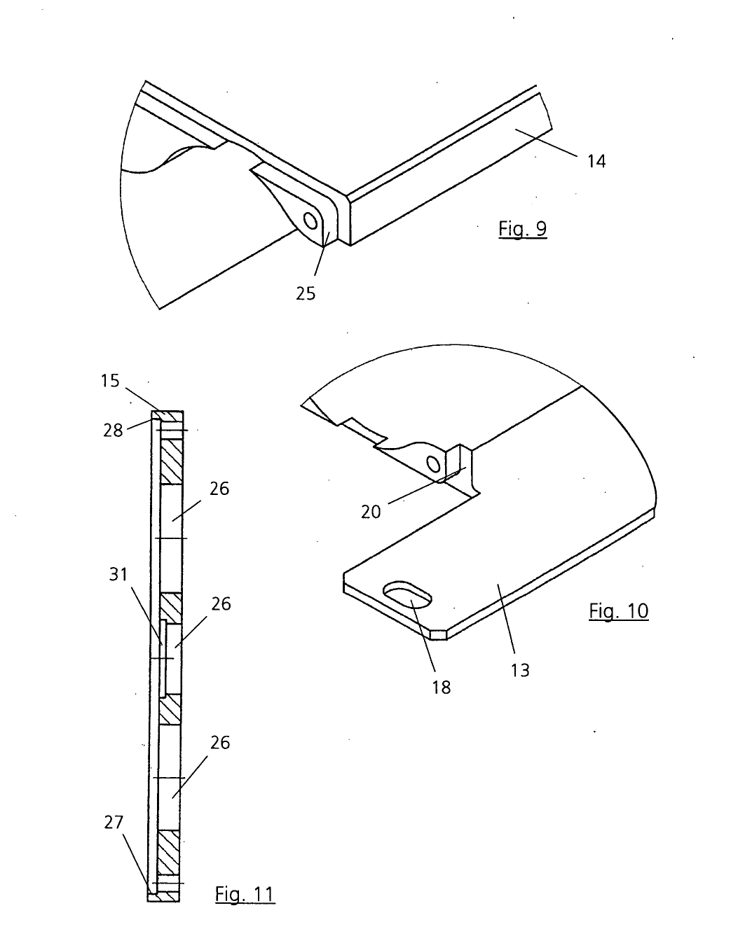

The upper support pressure plate 14 also has a curved, radius contour 24, which, as in the case of the lower pressure plate 13, is matched to the radius contour of the associated heat exchange channels 3, and centers them appropriately. On the sides, the upper support pressure plate 14 has clamping grooves 25 at the ends. The clamping grooves 25 likewise are used to absorb a defined pressure force uniformly via the side support clamping plates 15 and 16 (see the detail X and the enlarged illustration in FIG. 9).

The side support clamping plates 15 and 16 each have a number of openings 26, whose diameters are matched to the cells 2 and to the supply line parts and distribution lines for the heat exchange units. The cells 2 are secured against rotation by means of the quadrilateral openings which are shown. They are secured against rotation because the cells 2 must be tightened with a defined torque, for coupling to corresponding connectors.

The side support clamping plates 15 and 16 also have clamping frames 27, 28, 29 and 30, which absorb the defined pressure force from the support lower pressure plate 13 and from the upper support pressure plate 14.

FIG. 11 shows the section XI-XI of FIG. 7, through the side support clamping plate 15. From the illustrated section profile, there is a centering hole 31, which fixes the modules and/or cells 2 in a defined manner in the X direction between the side support clamping plate 15 and the side support clamping plate 16. The centering hole 31 is coaxial with respect to an overlapping quadrilateral hole 26 in the side support clamping plate 15, in order to accommodate a cell 2.

FIG. 12 shows three cooling units 8,9, together with an arrangement of energy storage cells 2 mounted between the heat exchange or cooling channels 3 of the cooling units 8,9. The support pressure plate mount 13 is arranged underneath the cooling units 8 and 9 (see FIG. 13).

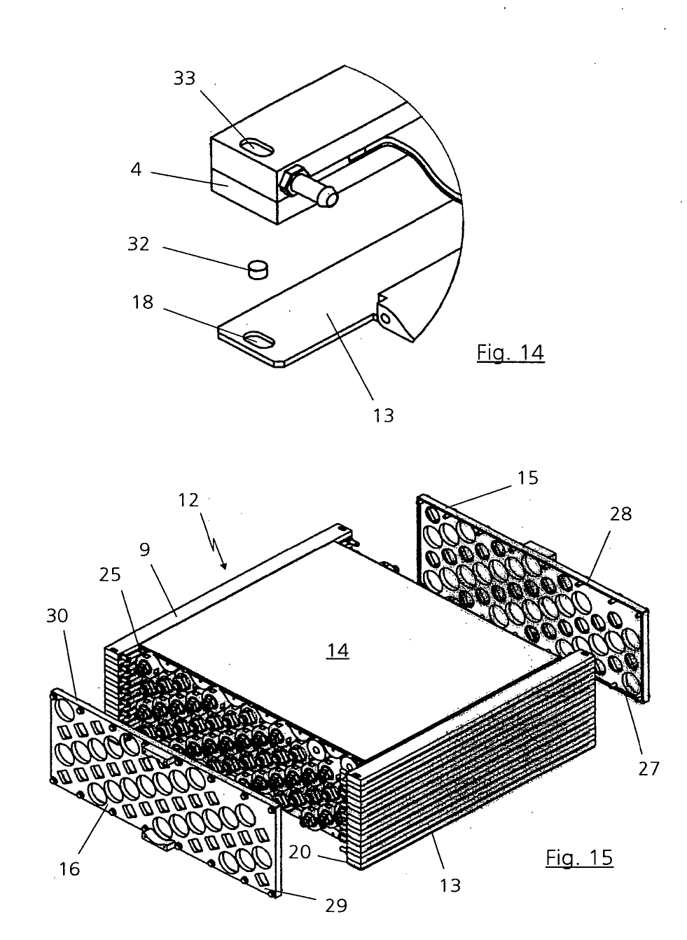

FIGS. 13 to 15 show the assembly and design of an energy store according to an exemplary embodiment of the present invention, including a plurality of heat exchange units 1 of the type illustrated in FIG. 1, and the energy storage cells 2, in the support housing 12. In the first step, a first cooling unit 8 is placed on the lower support pressure plate mount 13. Four centering bolts 32 are arranged in the cooling unit 8 and are inserted into the forward flow circulation distribution channels 4. The cooling unit 8 is inserted, with the centering bolt 32, into the elongated holes 18 in the lower support pressure plate mount 13. This results in the cooling unit 8 being fixed in the x direction as already described, with the elongated holes 18 allowing it to expand in the y direction. The cooling unit 8 has four elongated holes 33, which are used to fix the cooling unit 8 (see the detail Z and its enlarged illustration in FIG. 14).

The cells 2 are inserted into the cooling unit 8, as shown in FIG. 13. A second cooling unit 9 is then applied as a layer to the cells 2. The cooling unit 9 is provided with elongated holes 34. The cooling unit 9 likewise has four centering bolts 32, so that the second cooling unit 9 is fixed by means of the centering bolts 32 in the elongated holes 33 in the cooling unit 8 so that the second cooling unit 9 is likewise fixed in the x direction. As already mentioned, the elongated holes 33 allow the cooling units 8 and 9 to expand in the y direction without any stresses. As described above, the flow in the cooling unit 8 is in the opposite direction to the flow in the cooling unit 9. The rest of the construction of the storage cells 2 and of the cooling units 8 and 9 is carried out in the form of layers, again as clearly illustrated in FIG. 13.

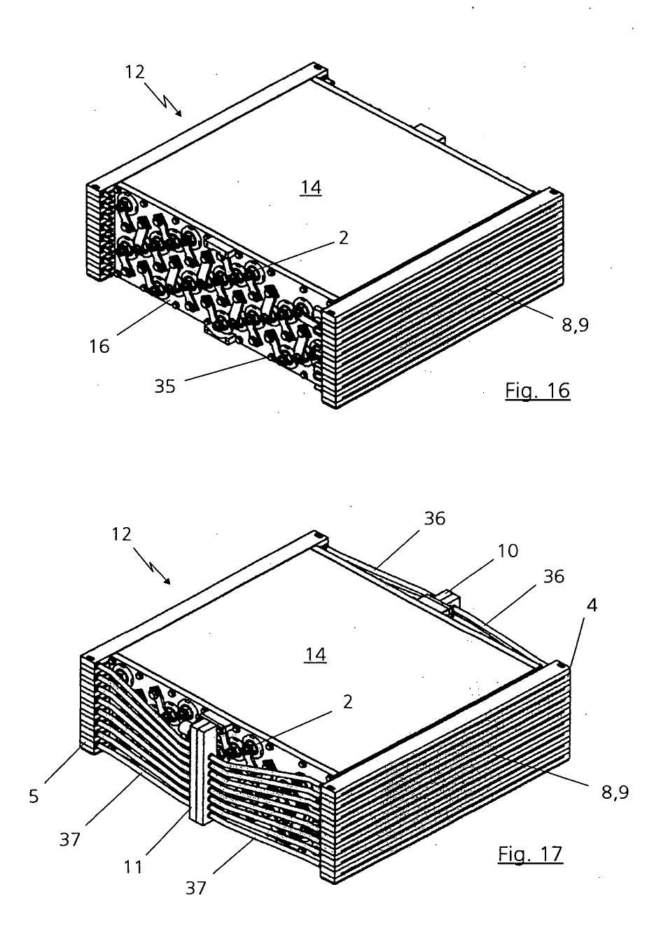

After the stack of layers of cooling unit 8, 9 and energy storage cells or modules 2 are aligned in their positions, the upper support pressure plate 14 is installed at the top of the layers (see FIG. 15). The upper support pressure plate 14 is compressed with a defined pressure force upon installation, so that the cooling surfaces rest on the storage cells 2 without any play, thus allowing for optimum heat transfer.

When the upper support pressure plate 14 is installed and aligned with the defined pressure force, the side support clamping plates 15 and 16 are inserted with their clamping frames 27 to 30 into the clamping grooves 25 on the lower support pressure plate 13, and with the upper support pressure plate 14 and the clamping grooves 25, and are screwed to the lower support pressure plate mount 13 and to the upper support pressure plate 14 for fixing in the x direction. It is also possible, of course, particularly when relatively large quantities are involved, to weld the parts mentioned above to one another.

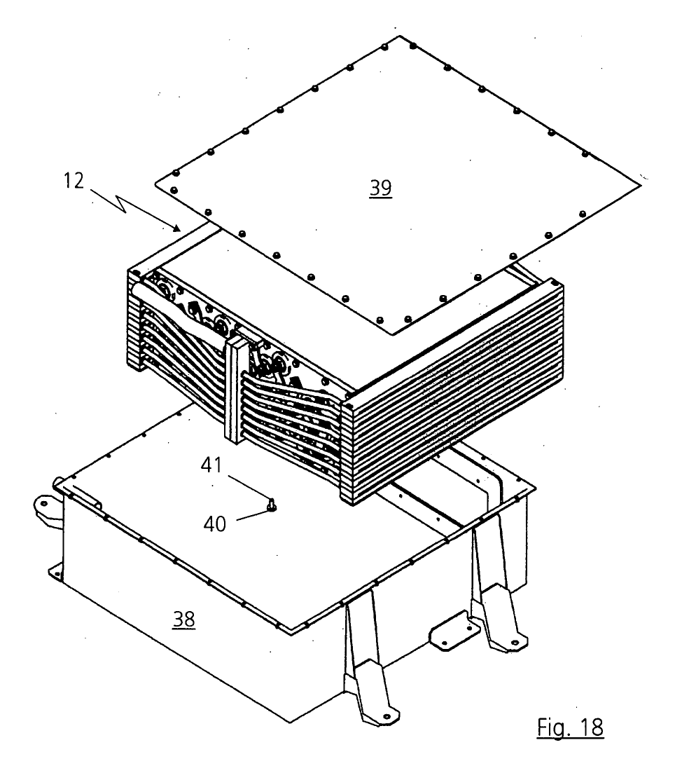

FIG. 16 shows a perspective view of a partially assembled self-supporting energy store according to the exemplary embodiment of the present invention, with its heat exchange units 8, 9, the storage cells 2 and the support housing 12. As can be seen, modular connectors 35 are coupled to the storage cells 2 for electrical connection of the cells 2.

FIG. 17 likewise shows a perspective view, in the completely assembled state, for the energy store, together with the support housing 12 according to a feature of the present invention. In addition, FIG. 17 also shows the forward flow distributor 10 with its connections 36 to form the forward flow circulation channels 4, and the return flow distributor 11 with its connections 37 to form the return flow circulation channels 5.

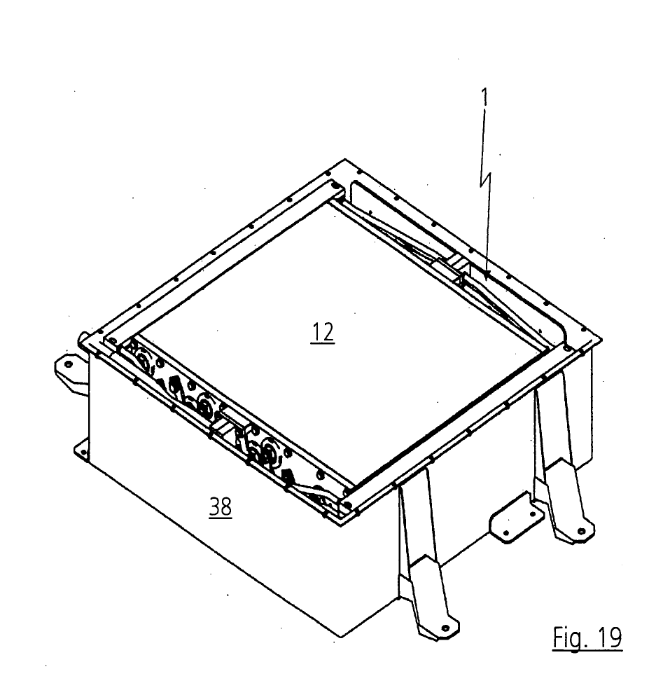

FIG. 18 shows a perspective illustration of the installation of the self-supporting energy store with the support housing 12, surrounding it, in a battery box 38. The battery box 38 is provided with a battery cover 39.

Four centering bolts 40 (only one of which is illustrated) are located on the battery box 38, so as to hold the self-supporting energy store with the support housing 12 in the centering holes 21 which are provided there, and thus, as described, to fix the energy store in the horizontal direction, with the shear forces being absorbed via the centering holes 21 and the centering bolts 40. The battery box 38 is screwed to the energy store via the threaded holes 22 which are incorporated in it, by means of attachment screws 41 in the battery box 38.

FIG. 19 shows a perspective view of the complete installation of the energy store with the support housing 12 according to a feature of the present invention, in the battery box 38.

One advantageous embodiment of the present invention provides a pressure-tight and water-tight battery box 38 being having at least one water outlet and venting device of the type illustrated in FIGS. 20-26.

FIGS. 20 to 26 show a water outlet and venting screw 42 with a water outlet and venting disc 43, for use as a water outlet and venting device for the battery box 38. In this case, FIG. 20 shows a perspective illustration of the water outlet and venting screw 42 with the water outlet and venting disc 43.

The water outlet and venting device according to the exemplary embodiment of the present invention not only allows pressure equalization but also, if necessary, allows any liquid which emerges from the heat exchange units to be passed into free space, so that no damage occurs to the electronic components or to the modules. The venting device may, of course, act in both directions; that is to say, if the pressure in the interior of the battery box is lower than the outside pressure, pressure equalization with the environment is likewise possible.

FIG. 21 shows an exploded illustration of the two parts of the water outlet and venting device according to the present invention, before their connection. The water outlet and venting disc 43 has a threaded hole 44. Four holes 45 are provided transversely with respect to and communicate with the threaded hole 44. The holes 45 are incorporated in a defined manner such that they are flush with the base of the battery box 38, so that any emerging water can be passed directly into free space.

The water outlet and venting screw 42 has a blind hole 46 (see FIG. 24). Four further holes 47 are provided transversely with respect to and communicate with the blind hole 46. Furthermore, the water outlet and venting screw 42 has a water catchment groove 48. The function of the water catchment groove 48 is to hold the water which enters the holes 45 via the water outlet and venting disc 43, and to pass this water via the hole 47 into four additional holes 49 in the water outlet and venting screw 42. The holes 49 are likewise arranged transversely with respect to and communicate with the blind hole 46, and from where the water is dissipated into free space. The arrangement of the water outlet and venting screw 42 and of the water outlet and venting disc 43 in the base of the battery box 38 is illustrated in FIG. 28. As is illustrated, the water outlet and venting disc 43 is in this case located in the interior of the battery box 38, and the water outlet and venting screw 42 is located on the outside of the battery box 38.

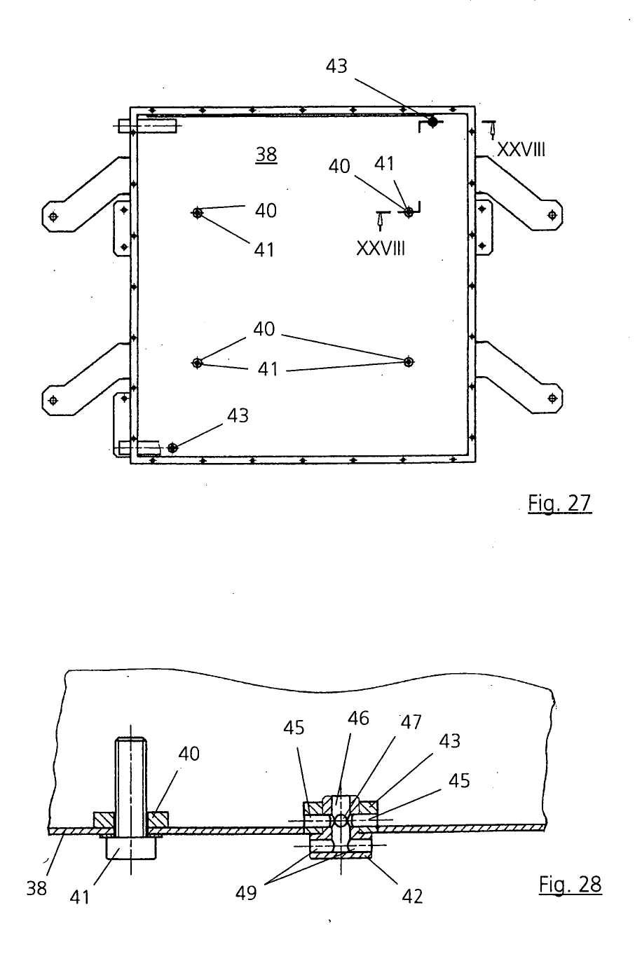

FIG. 27 shows a plan view of the battery box 38 and illustrates the positioning of the four centering bolts 40 and the four attachment screws 41, as well as two-diagonally opposed water outlet and venting discs 43.

FIG. 28 shows a section of the battery box 38, along line XXVIII-XXVIII of FIG. 27, and illustrates the arrangement of holes 45, 46, 49 when the water outlet and venting screw 42 and the water outlet and venting disc 43 are mounted in the base of the battery box 38.

The water outlet groove 48 may also be incorporated into the water outlet and venting disc 43 instead of the water outlet and venting screw 42. In the same way, the water outlet and venting disc 43 may be arranged on the outside, and the water outlet and venting screw 42 on the inside of the battery box 38. The water outlet and venting disc 43 can be welded to the battery box 38, or connected to the battery box 38 in any other desired manner.

The water outlet and venting screw 42 thus not only provides ventilation and venting for the battery box 38, but also an outlet for hydrogen to dissipate from the cells, if this emerges. The cooling liquid is likewise passed directly into free space outside of the battery box 38 in the event of any leaks in the heat exchange units.

FIG. 29 shows a perspective view of the electrochemical energy store with its self-supporting structure in the battery box 38. An external cooling circuit has an external cooler 50 with an axial fan, a water pump 51 and an equalization container 52.

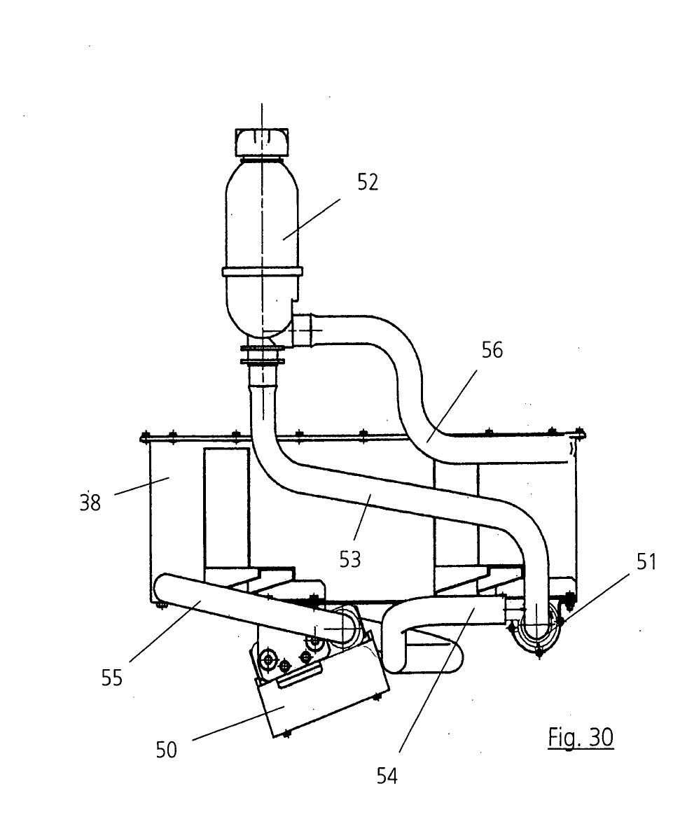

In addition, FIG. 30 also shows a forward flow line 53 to the water pump 5l, in a side view. A connection 54 for the external cooler 50, with the axial fan, emerges from the water pump 51. A connection 55 is provided from the external cooler 50 for the battery box 38. The return flow from the battery box 38 passes via a connection 56 to the equalization container 52.

The cooling circuit, which is known per se, ensures optimum filling and venting of the entire cooling circuit. The venting in this case takes place via the return flow from- the battery box 38 directly through the line to the equalization container 52. The supply air for the external cooling circuit is not supplied directly between the vehicle floor and the roadway, but from the interior venting, which is normally passed into free space at the side on the left and right, as forced venting. This outlet can be supplied to the external cooling circuit.

A direct supply of supply air from the area under the floor and from the roadway to the external cooling circuit would have the disadvantage that this air would have been heated by radiation heat emitted from the engine and, when the outside temperatures are very high, additionally by roadway heat from the roadway area as well. When the outside temperatures are very high, this could result in the battery not being cooled sufficiently, and, on the contrary, it would even be heated. In addition, a supply air channel can also be provided from the vehicle ventilation system for the outlet air from the interior ventilation, carrying air which has been cooled by the air-conditioning system or has been heated by the engine heat to the external cooling circuit. This allows the battery to be optimally cooled not only when the outside temperatures are very high, but also when they are very low.

When the outside temperatures are very low, this embodiment has a further advantage, specifically in that the battery is not cooled, but is heated by the engine heat, which in fact heats the interior, with box 38. The return flow from the battery box 38 passes via a connection 56 to the equalization container 52.

A further option for the external cooling circuit would be a direct link to the air-conditioning system. In this case, the external cooling circuit would be replaced.

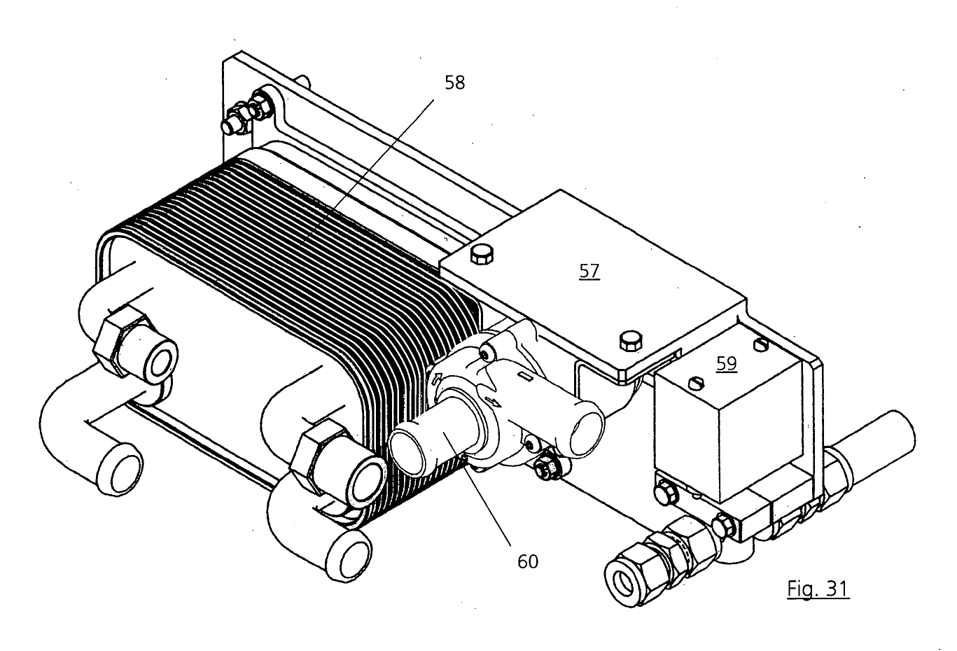

FIG. 31 shows a perspective view of one embodiment with an external cooling component configuration with a cooling component holder 57, a heat exchange/vaporizer 58, an expansion valve 59 and a water pump 60.

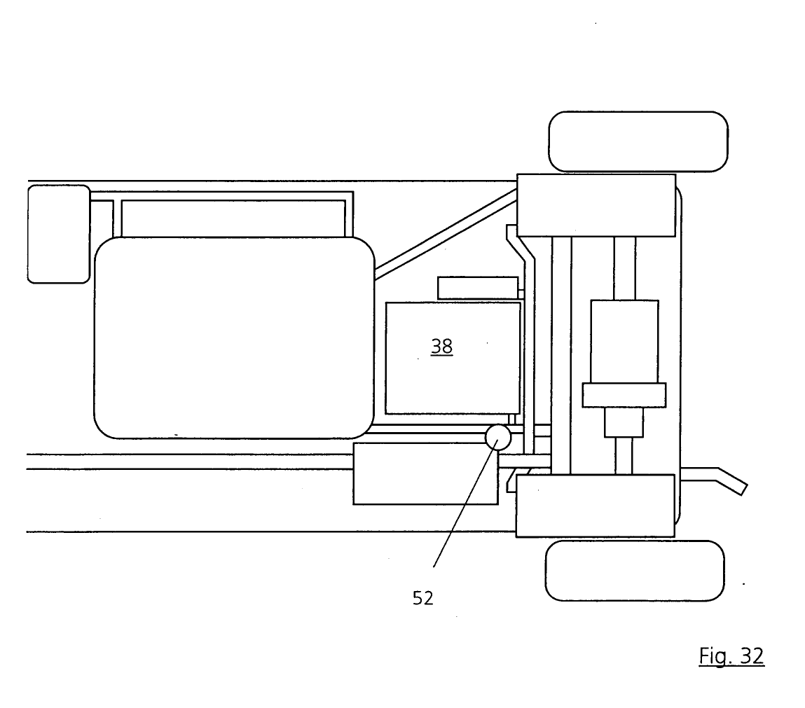

FIG. 32 shows a plan view of a battery box 38 which has already been installed in a vehicle, and in which the self-supporting energy store is arranged. The arrangement of the cooling component configuration from FIG. 31 is likewise illustrated, with a direct link to an air-conditioning system and with an equalization container 52.

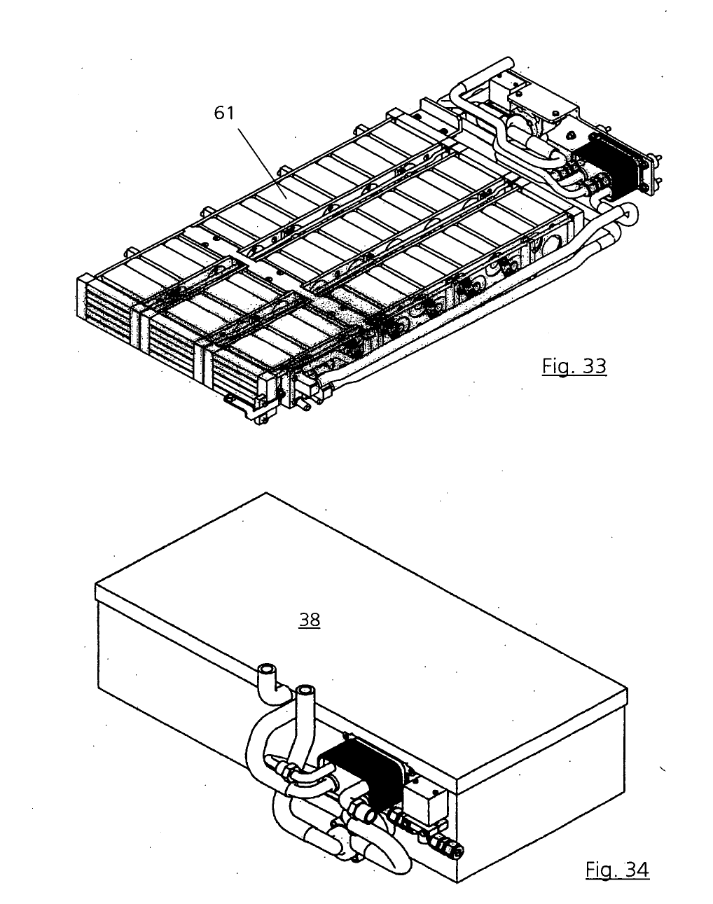

FIG. 33 shows a perspective view of a self-supporting battery liquid cooler with lithium ion cells 61 and the external cooling components as shown in FIG. 31, likewise with the arrangement being directly linked to the air-conditioning system.

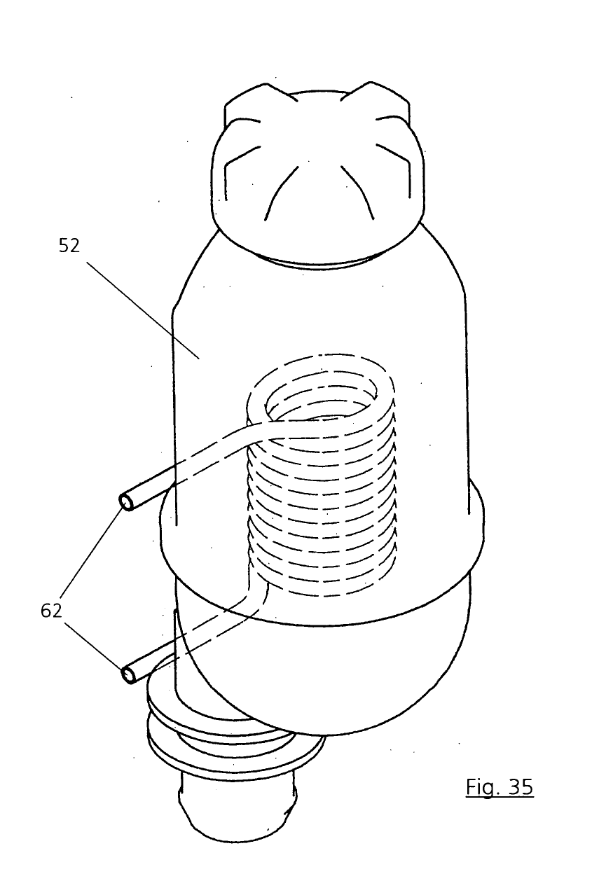

FIG. 34 shows a further perspective view of a battery box 38 with lithium ion cells and with external cooling components as shown in FIG. 31, which is flange-connected directly to the battery box 38.

FIG. 35 shows a perspective view of the equalization container 52 with a spiral cooling line 62 in the equalization container 52. The connection passes directly from the equalization container 52 to the water pump 60, and from there out of the battery box 38 and as a return pump from the battery box 38 back to the equalization container 52.

In this embodiment, the cooling components, such as the cooling components holder 57, are omitted, as are the heat exchange 58 and the expansion valve 59. The cooling circuit initially passes from the equalization container 52 directly via the water pump 60 into the interior of the battery box 38 to the heat exchange units, and from there back again to the equalization container 52. For cooling at high outside temperatures, the cooling line 62 is passed from an air-conditioning compressor (not illustrated) in a spiral shape through the equalization container 52, and is then passed back again to the air-conditioning compressor.

Since additional external cooling is required for battery cooling only in high outside temperatures, and the air-conditioning system is in operation in this situation in any case, the refinement as described above is a cost-effective and simple solution. No additional external cooling would be required for cooling the battery at temperatures, for example, below 20° C.

In the preceding specification, the invention has been described with reference to specific exemplary embodiments and examples thereof. It will, however, be evident that various modifications and changes may be made thereto without departing from the broader spirit and scope of the invention as set forth in the claims that follow. The specification and drawings are accordingly to be regarded in an illustrative manner rather than a restrictive sense.

1. An electrochemical store, which comprises:
a plurality of heat exchange units;
a plurality of electrochemical storage cells arranged in an array, alongside one another, and between pairs of the heat exchange units;
the heat exchange units including heat exchange channels for flow of a temperature control fluid;
a forward flow distribution channel coupled to the heat exchange channels for ingress of the temperature control fluid;
a return flow distribution channel coupled to the heat exchange channels for egress of the temperature control fluid flow; and
a pressure-tight and watertight battery box arranged to receive and enclose the heat exchange units and the electrochemical storage cells;
the battery box being arranged and configured to mount a water outlet and venting device.

2. The electrochemical store of claim 1 wherein the water outlet and venting device comprises a water outlet and venting screw and a water outlet and venting disc.

3. The electrochemical store of claim 2 wherein the water outlet and venting screw and the water outlet and venting disc are coupled to one another by a threaded connection.

4. The electrochemical store of claim 3 wherein the water outlet and venting screw and the water outlet and venting disc are each formed to include transverse holes extending there through, for water egress and venting.

5. The electrochemical store of claim 4 wherein the water outlet and venting disc is arranged within the battery box such that the transverse holes of the water outlet and venting disc are flush with a base portion of the battery box, and the water outlet and venting screw is arranged on the outside of the battery box, and coupled to the water outlet and venting disc by the threaded connection.

6. The electrochemical energy store of claim 4 wherein the water outlet and venting screw is formed to include a water catchment groove.

7. The electrochemical energy store of claim 4 wherein the water outlet and venting screw includes a central blind hole in communication with the transverse holes of the water outlet and venting screw.
